(19) United States
(12) Patent Application Publication
(10) Pub. No.: US 2026/0319350 A1
(43) Pub. Date: Oct. 15, 2026

(54) OPTICAL MODULE AND PROJECTOR

(71) Applicant: SEIKO EPSON CORPORATION, Tokyo (JP)

(72) Inventors: Yutaka AMANO, MATSUMOTO-SHI (JP); Masanori YASUDA, MATSUMOTO-SHI (JP); Tomoya MIZUTANI, AZUMINO-SHI (JP); Kiyomi SATO, MATSUMOTO-SHI (JP)

(21) Appl. No.: 19/642,009

(22) Filed: Apr. 8, 2026

(30) Foreign Application Priority Data
Apr. 9, 2025 (JP) 2025-064110

(51) Int. Cl. G03B 21/20

(52) U.S. Cl. CPC G03B 21/2073; G03B 21/2013

(57) ABSTRACT

An optical module according to the present disclosure includes: a first light source including a light emitting element configured to emit excitation light and a wavelength conversion element configured to convert the excitation light into light in a different wavelength band; a filter that cuts the excitation light contained in light incident from the first light source; and a polarization plate on which the light transmitted through the filter is incident, wherein at least one of the filter and the polarization plate is disposed so as to be inclined from a state perpendicular to an optical axis of the light emitted from the first light source.

The present application is based on, and claims priority from JP Application Serial Number 2025-064110, filed Apr. 9, 2025, the disclosure of which is hereby incorporated by reference herein in its entirety.

### BACKGROUND

### 1. Technical Field

The present disclosure relates to an optical module and a projector.

### 2. Related Art

There is a known projector of related art including a light source that emits a light, a light modulation device that modulates the light emitted from the light source in accordance with image information to generate an image light, and a projection optical system that enlarges and projects the image light emitted from the light modulation device onto a projection surface such as a screen.

JP-A-2000-180962 discloses a projector including an LED light source that emits a light, a block-shaped light guide element that emits the light emitted from the LED light source from an emission end with uniform brightness, a condenser lens that forms a light source image of the light emitted from the light guide element at the incident pupil position of a projection lens, a light modulation element that generates an image light, and the projection lens.

JP-A-2000-180962 is an example of the related art.

For example, a light source that generates green light by exciting a phosphor with excitation light having a short wavelength may be used in some cases in the projector described above. In such a case, it is conceivable to provide a filter that cuts short wavelength light, but there is a concern that the short wavelength light that fails to be cut by the filter causes multiple reflection between the filter and the optical member in the subsequent stage to reduce the reliability of an optical element.

### SUMMARY

In order to solve the problem described above, an optical module according to an aspect of the present disclosure includes: a first light source including a light emitting element configured to emit excitation light and a wavelength conversion element configured to convert the excitation light into light in a different wavelength band; a filter that cuts the excitation light contained in light incident from the first light source; and a polarization plate on which the light transmitted through the filter is incident, wherein at least one of the filter and the polarization plate is disposed so as to be inclined from a state perpendicular to an optical axis of the light emitted from the first light source.

A projector according to an aspect of the present disclosure includes a first image forming module including the optical module according to the aspect described above, and a first light modulation element configured to modulate light incident from the polarization plate of the optical module based on image information.

### BRIEF DESCRIPTION OF THE DRAWINGS

FIG. 1 is a plan view showing a schematic configuration of a projector according to an embodiment.

FIG. 2 is a diagram showing an arrangement configuration of a filter and a polarization plate in a comparative example.

FIG. 3 is a diagram showing an arrangement configuration of a filter and a polarization plate in the embodiment.

FIG. 4A is a diagram showing an arrangement configuration of a filter and a polarization plate viewed along an optical axis.

FIG. 4B is a plan view showing the arrangement configuration of the filter and the polarization plate viewed from a +D3 side.

FIG. 5 is a diagram showing a behavior of a transmission component in a green optical module.

FIG. 6 is a perspective view of a first light guide element.

FIG. 7 is a plan view showing a peripheral configuration of the light guide element.

FIG. 8 is a cross-sectional view taken along a line VIII in FIG. 7.

FIG. 9 is a schematic diagram illustrating a behavior of leakage light.

FIG. 10 is a diagram showing an arrangement configuration of a filter and a polarization plate related to a modified example.

### DESCRIPTION OF EMBODIMENTS

An embodiment of the present disclosure will be described below with reference to the drawings.

A projector according to the present embodiment is an example of a liquid crystal projector using liquid crystal panels as light modulation devices.

In the following drawings, elements are drawn at different dimensional scales in some cases in order to make the elements eye-friendly.

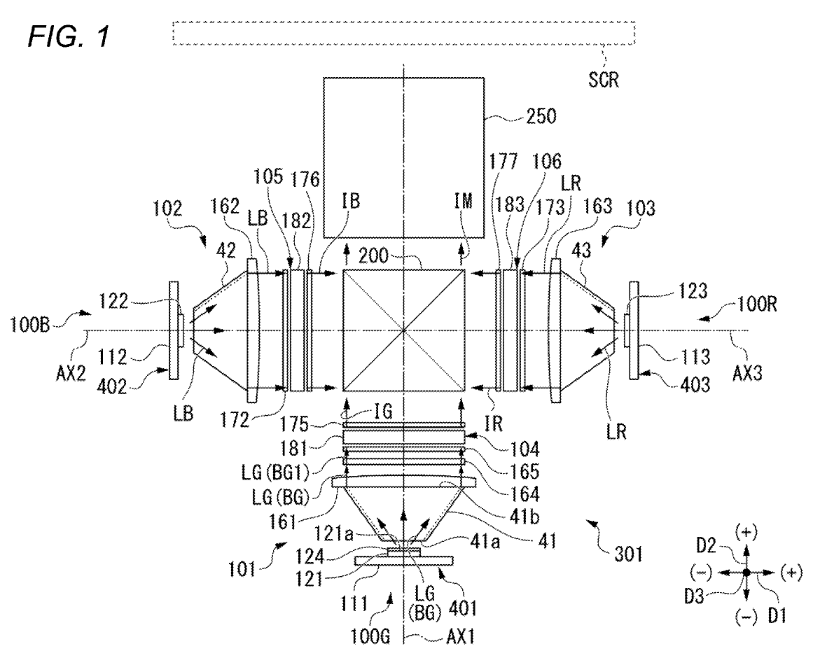

FIG. 1 is a plan view showing a schematic configuration of the projector according to the embodiment.

A projector 301 is an image display apparatus including three liquid crystal panels as the light modulation devices, and is what is called a three-plate projector, as shown in FIG. 1. The projector 301 includes a first image forming module 100G, a second image forming module 100B, a third image forming module 100R, a light combining element 200, and a projection optical system 250.

The first image forming module 100G includes a green optical module (optical module) 101 and a green light modulation device 104. The second image forming module 100B includes a blue optical module 102 and a blue light modulation device 105. The third image forming module 100R includes a red optical module 103 and a red light modulation device 106.

In the following description, a direction parallel to an optical axis of blue light LB emitted from the blue optical module 102 is defined as a D1 direction. One side in the D1 direction is defined as a -D1 side, and a side opposite the -D1 side in the D1 direction is defined as a +D1 side. A direction perpendicular to the D1 direction in a plane including the optical axis of the blue light LB is referred to as a D2 direction. One side in the D2 direction is referred to as a -D2 side, and a side opposite the -D2 side in the D2 direction is referred to as a +D2 side. A direction perpendicular to the D1 direction and the D2 direction is referred to as a D3 direction. The blue light LB emitted from the blue optical module 102 travels toward the +D1 side along the D1 direction.

First, the first image forming module 100G will be described. The green optical module 101 of the first image forming module 100G includes a first light source 401, a first light guide element (light guide element) 41, a first collimating element 161, a filter 164, and a polarization plate 165. In the green optical module 101, the first light source 401, the first light guide element 41, the first collimating element 161, the filter 164, and the polarization plate 165 are arranged along the optical axis AX1 of the first light source 401. The optical axis AX1 of the first light source 401 is an axis along a principal ray of light radially emitted from the first light source 401, and is an axis extending in parallel to the D2 direction.

The first light source 401 includes a first substrate 111, a first light emitting element 121 mounted on the first substrate 111, and a wavelength conversion element 124 provided to a light emitting surface 121a of the first light emitting element 121. The first substrate 111 is a plate parallel to a plane including the D1 direction and the D3 direction.

The first light emitting element 121 is an LED that emits excitation light BG for exciting the wavelength conversion element 124 from the light emitting surface 121a. The excitation light BG is light in a wavelength band of, for example, 400 nm to 450 nm, and has a peak wavelength at 420 nm. The excitation light BG is light containing relatively more short wavelength light than the blue light LB described later. The excitation light BG has the shortest wavelength out of the colored light used in the projector 301, and is therefore high in energy.

The wavelength conversion element 124 is a green phosphor that converts the excitation light BG into green light (light in a different wavelength band) LG having a green wavelength band of 500 nm to 560 nm. In the first light source 401, a part of the excitation light BG is not converted by the wavelength conversion element 124 into the green light LG but is transmitted through the wavelength conversion element 124. Therefore, the first light source 401 emits light containing the green light LG and the excitation light BG toward the first light guide element 41.

The first light guide element 41 is disposed at a light exit side of the first light source 401, and is disposed at the +D1 side of the first light emitting element 121 of the first light source 401 and at a position where the first light guide element 41 overlaps the first light emitting element 121 in the D1 direction and the D3 direction. The first light guide element 41 will be described later in detail.

The first collimating element 161 is disposed on an optical path of the light emitted from the first light guide element 41. The first collimating element 161 collimates the light emitted from the first light guide element 41 along the D2 direction.

As described above, the excitation light BG contained in the light emitted by the first light source 401 causes the color tone of the image light to deteriorate in the first image forming module 100G. In contrast, the green optical module 101 of the present embodiment includes the filter 164 that cuts the excitation light BG contained in the light emitted from the first light source 401. The filter 164 is disposed on an optical path of the green light LG emitted from the first collimating element 161.

The filter 164 has an optical characteristic of reflecting the excitation light BG and transmitting the green light LG. The excitation light BG reflected by the filter 164 returns to the first light source 401 via the first light guide element 41 and is used for re-excitation of the wavelength conversion element 124. By returning the excitation light BG to the first light source 401 in this manner, the conversion efficiency of the wavelength conversion element 124 can be increased.

The green light LG transmitted through the filter 164 is incident on the polarization plate 165. The polarization plate 165 emits predetermined polarized light out of the green light LG toward the +D2 side along the D2 direction. The polarization plate 165 is a reflective polarization plate.

Incidentally, it is difficult to cut the excitation light BG by 100 % in the filter 164, and about 1 % of the excitation light BG is transmitted through the filter 164. A transmission component BG1 of the excitation light BG transmitted through the filter 164 is incident on the polarization plate 165, and at least a part of the transmission component BG1 is reflected by the polarization plate 165.

The transmission component BG1 reflected by the polarization plate 165 is incident on the filter 164 once again. Since the filter 164 has a characteristic of reflecting the excitation light BG, the transmission component BG1 is reflected again by the filter 164 and enters the polarization plate 165. It is considered that the polarization plate 165 reflects, toward the filter 164, at least a part of the transmission component BG1 thus incident again on the polarization plate 165, and thus multiple reflection of the transmission component BG1 occurs between the filter 164 and the polarization plate 165.

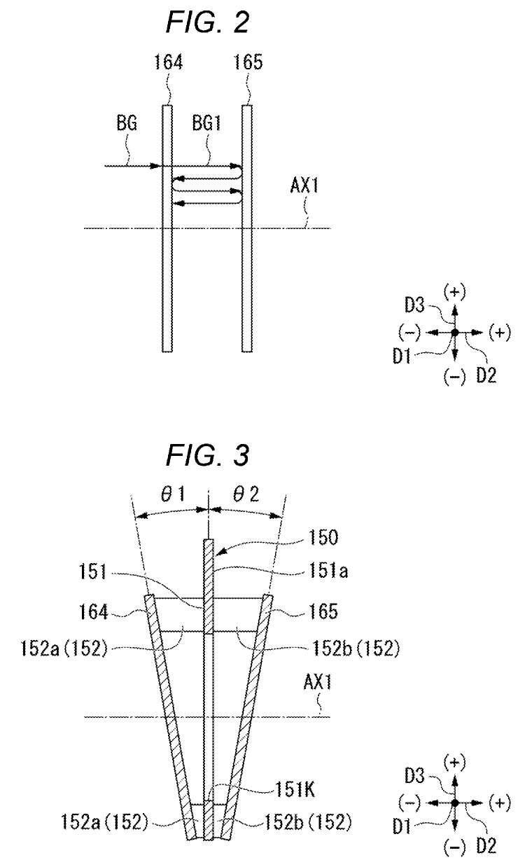

Here, the relationship between the arrangement of the filter 164 and the polarization plate 165 and the multiple reflection will be described with reference to a configuration of a comparative example. FIG. 2 is a diagram showing an arrangement configuration of the filter 164 and the polarization plate 165 in a comparative example. A difference in configuration between the green optical module 101 of the present embodiment and the comparative example is the arrangement of the filter 164 and the polarization plate 165 with respect to the optical axis AX1, and the other portions of the configuration are the same.

As shown in FIG. 2, in the configuration of the comparative example, the filter 164 and the polarization plate 165 are arranged in a state perpendicular to the optical axis AX1 of the first light source 401.

Since the transmission component BG1 that travels in parallel to the optical axis AX1 is perpendicularly incident on the polarization plate 165 as shown in FIG. 2, the multiple reflection is likely to occur between the filter 164 and the polarization plate 165. Since the excitation light BG is collimated by the first collimating element 161 to be incident on the filter 164, the transmission component BG1 of the excitation light BG transmitted through the filter 164 contains much component traveling in parallel to the optical axis AX1. Therefore, when the filter 164 and the polarization plate 165 are disposed perpendicularly to the optical axis AX1 as in the configuration of the comparative example, there is a possibility that a large amount of multiple reflection component of the transmission component BG1 is generated between the filter 164 and the polarization plate 165, and deterioration of the polarization plate 165 is promoted to thereby reduce the reliability.

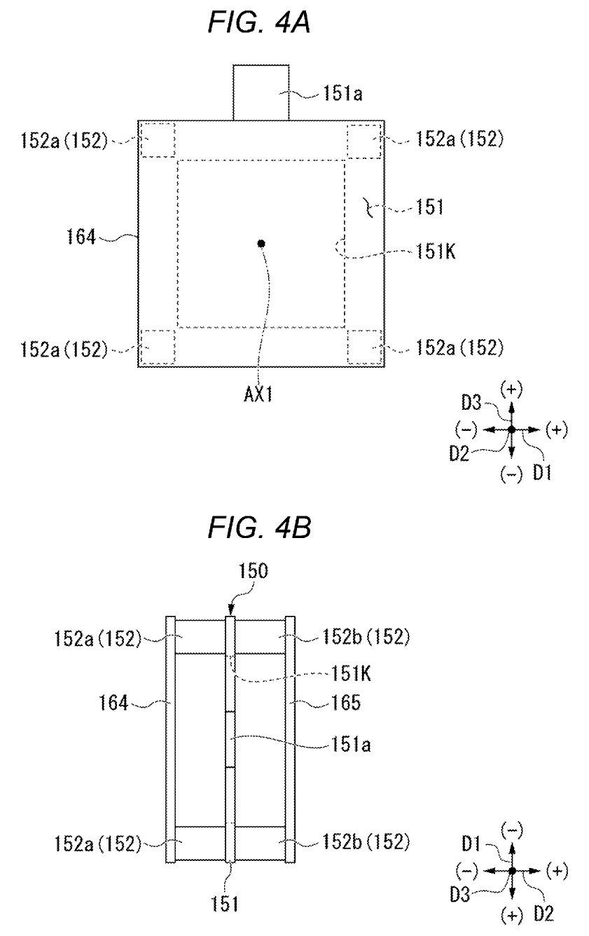

FIG. 3 is a diagram illustrating an arrangement configuration of the filter 164 and the polarization plate 165 in the green optical module 101 of the present embodiment. FIG. 4A is a diagram illustrating an arrangement configuration of the filter 164 and the polarization plate 165 viewed in the D2 direction from the -D2 side toward the +D2 side along the optical axis AX1. FIG. 4B is a plan view of the arrangement configuration of the filter 164 and the polarization plate 165 viewed from the +D3 side.

As illustrated in FIG. 3, the filter 164 and the polarization plate 165 are disposed to be inclined from a state perpendicular to the optical axis AX1 of the first light source 401.

The green optical module 101 of the present embodiment further includes a holding member 150 that is disposed between the filter 164 and the polarization plate 165 to hold the filter 164 and the polarization plate 165.

The holding member 150 holds the filter 164 and the polarization plate 165 in a state of being non-parallel to each other. As shown in FIG. 4A, the holding member 150 includes a frame-shaped body 151 and a fixing member 152. The frame-shaped body 151 is a frame member shaped like a rectangular frame having an opening 151K. The frame-shaped body 151 is fixed to a housing (not shown) inside the projector 301 via an attachment portion 151a disposed in an end portion at the +D3 side. The frame-shaped body 151 is disposed in a state perpendicular to the optical axis AX1, specifically, in parallel to a plane including the D1 direction and the D3 direction.

The fixing member 152 is disposed around the opening 151K of the frame-shaped body 151, and fixes peripheral edge portions of the filter 164 and the polarization plate 165 to the frame-shaped body 151. The fixing member 152 is formed of an elastic member such as a double-sided adhesive tape or an adhesive.

The fixing member 152 includes first fixing portions 152a that fix the filter 164 to a surface at the -D2 side of the frame-shaped body 151, and second fixing portions 152b that fix the polarization plate 165 to a surface at the +D2 side of the frame-shaped body 151.

As illustrated in FIG. 4A, the first fixing portions 152a are disposed at four positions in total, that is, around both corners of the opening 151K at the +D3 side and both corners of the opening 151K at the -D3 side. Similarly to the first fixing portions 152a, the second fixing portions 152b are disposed at four positions in total, that is, around both corners of the opening 151K at the +D3 side and both corners of the opening 151K at the -D3 side. That is, as shown in FIG. 4B, the first fixing portions 152a and the second fixing portions 152b are disposed at the same positions on both surfaces of the frame-shaped body 151, respectively. The first fixing portions 152a and the second fixing portions 152b may be disposed at different positions in plan view as long as the positions do not overlap the opening 151K.

The planar sizes of the filter 164 and the polarization plate 165 are set to be larger than the light flux width of the light incident from the first light source 401. Therefore, the light from the first light source 401 hardly enters the peripheral portions of the filter 164 and the polarization plate 165 fixed to the frame-shaped body 151 via the fixing member 152.

The light incident on the filter 164 and the polarization plate 165 is transmitted through the frame-shaped body 151 via the opening 151K. The fixing member 152 is disposed around the opening 151K as described above. Therefore, the holding member 150 holds the filter 164 and the polarization plate 165 without blocking the light to be incident on the filter 164 and the polarization plate 165.

The filter 164 is inclined toward the -D2 side from a state perpendicular to the optical axis AX1 in a plane including the D2 direction and the D3 direction. Specifically, the filter 164 is inclined with respect to the optical axis AX1 such that an end portion at the +D3 side is located at the -D2 side with respect to an end portion at the -D3 side.

The polarization plate 165 is inclined toward the +D2 side from a state perpendicular to the optical axis AX1 in a plane including the D2 direction and the D3 direction. Specifically, the polarization plate 165 is inclined with respect to the optical axis AX1 such that an end portion at the +D3 side is located at the +D2 side with respect to an end portion at the -D3 side.

In FIG. 3, an angle between the filter 164 and the frame-shaped body 151 perpendicular to the optical axis AX1 is defined as θ1, and an angle between the polarization plate 165 and the frame-shaped body 151 perpendicular to the optical axis AX1 is defined as θ2.

The filter 164 is inclined at the angle θ1 from the state perpendicular to the optical axis AX1, and the polarization plate 165 is inclined at the angle θ2 from the state perpendicular to the optical axis AX1 oppositely to the filter 164. The angle θ1 and the angle θ2 are preferably set in ranges of 0°<θ1≤5° and 0°<θ2≤5°, respectively. In addition, it is more preferable to set the angles in ranges of θ1≥0.1° and θ2≥0.1°, respectively, and it is more preferable to set the angles in ranges of θ1≥0.2° and θ2≥0.2°, respectively.

According to this configuration, since the filter 164 and the polarization plate 165 are disposed at appropriate angles with respect to the optical axis AX1, the transmission component BG1 of the excitation light BG reflected between the filter 164 and the polarization plate 165 can be favorably emitted to the outside of the filter 164 and the polarization plate 165 as described later.

When the angles θ1, θ2 described above are satisfied, the filter 164 and the polarization plate 165 may be parallel to each other in some cases although both the filter 164 and the polarization plate 165 are inclined from the state perpendicular to the optical axis AX1.

When the filter 164 and the polarization plate 165 are parallel to each other as described above, the light incident from a direction perpendicular to the filter 164 out of the transmission component BG1 may be multiply reflected between the filter 164 and the polarization plate 165 in some cases as in the configuration of the comparative example.

Therefore, in the holding member 150 in the present embodiment, for example, both the angle θ1 and the angle θ2 are set to 0.6°, and the filter 164 and the polarization plate 165 are held so as to be non-parallel to each other.

The inclination of the filter 164 with respect to the optical axis AX1 is adjusted by the thicknesses of the first fixing portions 152a. The first fixing portions 152a can set the angle θ1 by making the thickness at the +D3 side of the opening 151K larger than the thickness at the -D3 side of the opening 151K.

The inclination of the polarization plate 165 with respect to the optical axis AX1 is adjusted by the thicknesses of the second fixing portions 152b. The second fixing portions 152b can set the angle θ2 by making the thickness at the +D3 side of the opening 151K larger than the thickness at the -D3 side of the opening 151K.

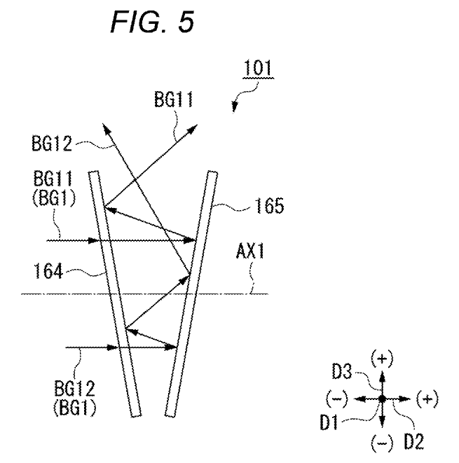

FIG. 5 is a diagram showing a behavior of the transmission component BG1 in the green optical module 101 in the present embodiment. In FIG. 5, only the filter 164 and the polarization plate 165 are illustrated and the holding member 150 is omitted in order to make the drawing easy to see.

As shown in FIG. 5, in the green optical module 101, the filter 164 and the polarization plate 165 are inclined from the state perpendicular to the optical axis AX1 and are non-parallel to each other. Specifically, the filter 164 and the polarization plate 165 are disposed such that a gap in the D2 direction between the filter 164 and the polarization plate 165 increases in a direction from the -D3 side toward the +D3 side in a plane including the D2 direction and the D3 direction.

As described above, since the excitation light BG having a short wavelength is light having high energy, when the transmission component BG1, which is a part of the excitation light BG, causes the multiple reflection between the filter 164 and the polarization plate 165, the transmission component BG1 deteriorates the polarization plate 165 to cause the reliability to decrease.

In contrast, in the green optical module 101 according to the present embodiment, a first transmission component BG11 incident on the +D3 side of the filter 164 out of the transmission component BG1 is reflected by the polarization plate 165 and the filter 164 to thereby be emitted from an area between the filter 164 and the polarization plate 165 toward the D3 direction orthogonal to the optical axis AX1. The first transmission component BG11 travels as stray light in the projector 301 and is then absorbed by a light absorption member (not shown).

In the case of the present embodiment, since the filter 164 and the polarization plate 165 are non-parallel to each other as described above, even when the transmission component BG1 is incident on the filter 164 at any incident angle, the multiple reflection is less likely to occur between the filter 164 and the polarization plate 165.

As described above, according to the green optical module 101 of the present embodiment, since the first transmission component BG11 transmitted through the filter 164 is not multiply reflected between the filter 164 and the polarization plate 165, it is possible to prevent the first transmission component BG11 having a short wavelength from deteriorating the polarization plate 165 due to the multiple reflection.

A direction of a second transmission component BG12 incident on the -D3 side of the filter 164 out of the transmission component BG1 is changed so as to approach a direction parallel to the D3 direction every time the second transmission component BG12 is reflected between the polarization plate 165 and the filter 164. The second transmission component BG12 is emitted from an area between the filter 164 and the polarization plate 165 toward the +D3 side in the D3 direction orthogonal to the optical axis AX1, then travels as stray light in the projector 301, and is absorbed by a light absorption member (not shown). Therefore, since the second transmission component BG12 is not multiply reflected between the filter 164 and the polarization plate 165, deterioration of the polarization plate 165 due to the multiple reflection can be suppressed.

As described above, according to the green optical module 101 of the present embodiment, since the filter 164 and the polarization plate 165 are inclined from the state perpendicular to the optical axis AX1, it is possible to change the direction of the transmission component BG1 of the excitation light BG toward the D3 direction orthogonal to the optical axis AX1 every time the transmission component BG1 is reflected between the filter 164 and the polarization plate 165, and to emit the transmission component BG1 of the excitation light BG to the outside of the area between the filter 164 and the polarization plate 165. Therefore, by preventing the transmission component BG1 of the excitation light BG from being multiply reflected between the filter 164 and the polarization plate 165, it is possible to provide a highly reliable optical module in which a decrease in reliability due to the deterioration of the polarization plate 165 caused by the excitation light BG having a short wavelength is suppressed.

In the green optical module 101 in the present embodiment, the green light LG having been transmitted through the filter 164 and the polarization plate 165 enters the green light modulation device 104.

The green light modulation device 104 includes a first light modulation element 181 and a first exit-side polarization element 175.

The first light modulation element 181 modulates the green light LG incident from the polarization plate 165 of the green optical module 101. The first light modulation element 181 is, for example, a transmissive liquid crystal panel. The liquid crystal panel constituting the first light modulation element 181 generates green image light IG by modulating the green light LG based on green image information. The first light modulation element 181 outputs the green image light IG thus generated toward the +D2 side along the D2 direction.

The first exit-side polarization element 175 is disposed at the +D2 side of the first light modulation element 181. The first exit-side polarization element 175 outputs predetermined polarized light toward the +D2 side along the D2 direction out of the green image light IG output from the first light modulation element 181. The first exit-side polarization element 175 is, for example, a reflective or absorptive polarization plate.

Then, the configuration of the first light guide element 41 will be described.

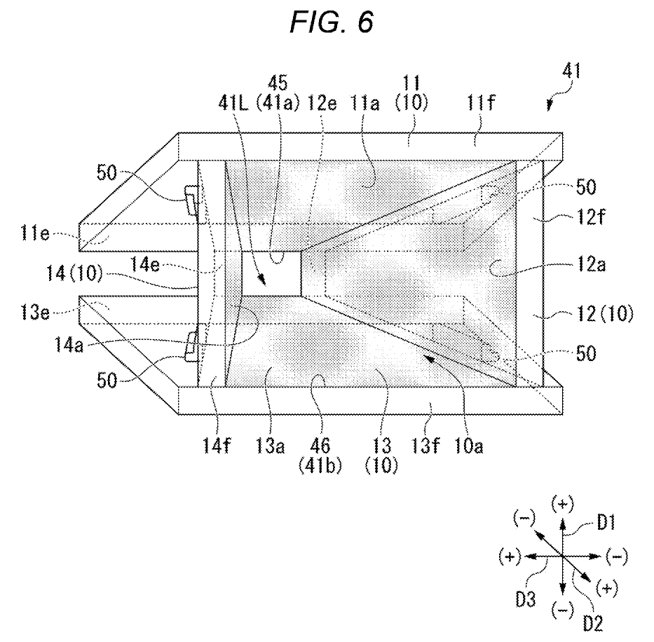

FIG. 6 is a perspective view of the first light guide element 41. As shown in FIG. 6, the first light guide element 41 defines a light guide path that guides the green light LG emitted from the first light emitting element 121, and propagates the green light LG to the first light modulation element 181. The first light guide element 41 includes a plurality of plate members 10 made of a transparent material and an adhesive 50. The plurality of plate members 10 includes a first member 11, a second member 12, a third member 13, and a fourth member 14.

The first member 11 and the third member 13 are a pair of rectangular plate members. The first member 11 has a first reflection surface 11a on one planar surface. The third member 13 has a third reflection surface 13a on one planar surface. The first member 11 and the third member 13 are plate members having the same shape.

The second member 12 and the fourth member 14 are a pair of trapezoidal plate members. The second member 12 has a second reflection surface 12a on one planar surface. The fourth member 14 has a fourth reflection surface 14a on one planar surface. The second member 12 and the fourth member 14 are plate members having the same shape. In the following description, when the first reflection surface 11a, the second reflection surface 12a, the third reflection surface 13a, and the fourth reflection surface 14a are not particularly distinguished from each other, these may be collectively referred to as reflection surfaces 10a in some cases. The reflection surface 10a forms a light guide path 41L that guides the green light LG to the inside of the first light guide element 41.

The first light guide element 41 can easily be manufactured by using the four plate members as described above. Since the first light guide element 41 is configured with the rectangular plate members, the number of times of the processing of the plate members can be reduced. Further, since the plate members each have a simple shape, the assembly thereof becomes easy.

Note that the plurality of plate members 10 constituting the first light guide element 41 may include two plate members. More specifically, the first member 11 and the second member 12 may be integrally formed. Similarly, the third member 13 and the fourth member 14 may be integrally formed.

The first reflection surface 11a of the first member 11 and the third reflection surface 13a of the third member 13 are disposed so as to face each other. The second reflection surface 12a of the second member 12 and the fourth reflection surface 14a of the fourth member 14 are disposed so as to face each other. The second member 12 and the fourth member 14 are each disposed so that an upper base thereof is located at the -D2 side and a lower base thereof is located at the +D2 side.

One side surface that is an oblique side portion of each of the second member 12 and fourth member 14 each having a trapezoidal shape is continued to the first reflection surface 11a of the first member 11. The other side surface that is another oblique side portion of each of the second member 12 and fourth member 14 is continued to the third reflection surface 13a of the third member 13. The plurality of plate members 10 is bonded to each other with the adhesive 50 described later. Thus, the shape of the first light guide element 41 is formed by the plurality of plate members 10.

The first member 11 has a first end plane of incidence 11e in an end portion at the -D2 side. The second member 12 has a second end plane of incidence 12e in the end portion at the -D2 side. The third member 13 has a third end plane of incidence 13e in the end portion at the -D2 side. The fourth member 14 has a fourth end plane of incidence 14e in the end portion at the -D2 side. A part of the first end plane of incidence 11e, the second end plane of incidence 12e, a part of the third end plane of incidence 13e, and the fourth end plane of incidence 14e form an incident opening 45. The incident opening 45 forms an incident end 41a of the light guide path 41L.

The first member 11 has a first exit end surface 11f in an end portion at the +D2 side. The second member 12 has a second exit end surface 12f in the end portion at the +D2 side. The third member 13 has a third exit end surface 13f in the end portion at the +D2 side. The fourth member 14 has a fourth exit end surface 14f in the end portion at the +D2 side. The first exit end surface 11f, the second exit end surface 12f, the third exit end surface 13f, and the fourth exit end surface 14f form an exit opening 46. The exit opening 46 forms an exit end 41b of the light guide path 41L.

The incident opening 45 spreads in parallel to the plane including the D1 direction and the D3 direction. The shape of the incident opening 45 viewed from the D2 direction is substantially the same as the shape of a light emitting surface of the first light emitting element 121 viewed from the same direction, and is a rectangular shape. The size of the incident opening 45 may be comparable to the size of the light emitting surface of the first light emitting element 121, but it is preferable that the incident opening 45 is appropriately larger than the light emitting surface of the first light emitting element 121.

The exit opening 46 spreads in parallel to the plane including the D1 direction and the D3 direction. The exit opening 46 is larger than the incident opening 45. The shape of the exit opening 46 when viewed from the D2 direction is a rectangular shape. The size of the exit end 41b is comparable to the size of the first light modulation element 181.

According to this configuration, it is possible to increase the luminous flux width in the process of propagating, within the light guide path, the green light LG incident from the incident opening 45. Accordingly, it is possible to generate the green light LG having a uniform illuminance distribution for efficiently illuminating the entire first light modulation element 181.

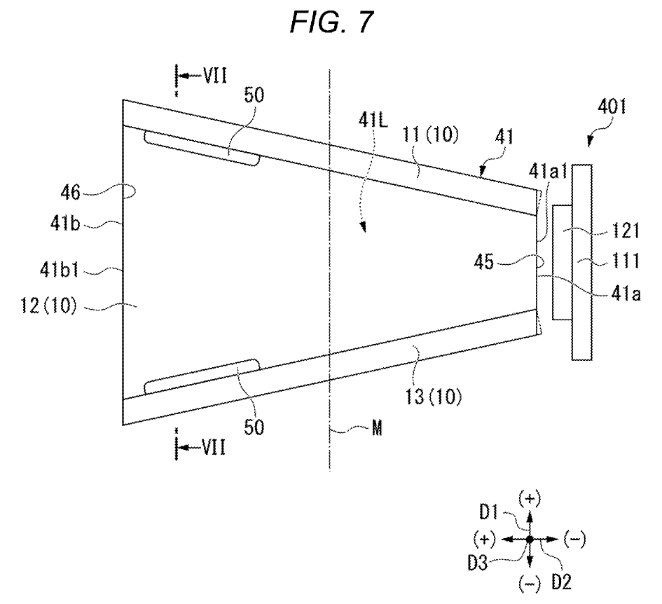

FIG. 7 is a plan view showing a peripheral configuration of a light guide element. As shown in FIG. 7, the light guide path 41L of the first light guide element 41 has the incident end 41a and the exit end 41b. The incident end 41a is located at the -D2 side in the D2 direction. The exit end 41b is located at the +D2 side in the D2 direction.

The first end plane of incidence 11e and the third end plane of incidence 13e are parallel to the plane including the D1 direction and the D3 direction. When normal plate members are directly bonded to each other, corners of the first end plane of incidence 11e of the first member 11 and the third end plane of incidence 13e of the third member 13 protrude toward the -D2 side, as represented by dotted lines in FIG. 7. In the present embodiment, the corners of the first end plane of incidence 11e and the third end plane of incidence 13e are cut off so as to be parallel to the plane including the D1 direction and the D3 direction. Similarly, the second end plane of incidence 12e and the fourth end plane of incidence 14e are parallel to the plane including the D1 direction and the D3 direction.

According to this configuration, a gap in the D2 direction between the incident opening 45 and the first light source 401 can be reduced. Therefore, the incident opening 45 and the first light source 401 can be disposed close to each other in the D2 direction. Therefore, an amount of leakage light LL generated while the light travels from the first light source 401 toward the incident opening 45 of the first light guide element 41 can be suppressed.

In the present embodiment, the first exit end surface 11f and the third exit end surface 13f are parallel to the plane including the D1 direction and the D3 direction. Similarly, the second exit end surface 12f and the fourth exit end surface 14f are parallel to the plane including the D1 direction and the D3 direction. The corners of the first end plane of incidence 11e and the third end plane of incidence 13e may be cut off so as to be parallel to the plane including the D1 direction and the D3 direction.

According to this configuration, the gap between the exit opening 46 and the first light modulation element 181 can be reduced. Therefore, the exit opening 46 and the first light modulation element 181 can be disposed so as to be close to each other. Therefore, the amount of the leakage light LL generated while the light travels from the exit opening 46 of the first light guide element 41 toward the first light modulation element 181 can be suppressed.

The green light LG output from the first light source 401 enters the light guide path 41L of the first light guide element 41 from the incident end 41a. In the first light guide element 41, a space surrounded by the incident opening 45, the exit opening 46, and the reflection surfaces 10a serves as the light guide path 41L through which the green light LG propagates. In this way, the green light LG that enters the first light guide element 41 propagates through the light guide path 41L from the -D2 side toward the +D2 side.

A part of the green light LG to be incident on the first light guide element 41 propagates directly from the incident end 41a to the exit end 41b, without a single entry to the reflection surfaces 10a, along a direction at an angle smaller than inclination angles of the oblique sides of the trapezoidal shapes of the second member 12 and the fourth member 14. A remaining part of the green light LG to be incident on the first light guide element 41 is incident on the reflection surfaces 10a from the incident end 41a at an angle equal to or larger than the angle described above at one or more times, is then reflected by the reflection surfaces 10a, and then reaches the exit end 41b. The paths of beams of the green light LG in a region surrounded by the incident end 41a, the exit end 41b, and the reflection surfaces 10a differ in accordance with the incident angle on the incident end 41a, and are a plurality of paths different in the number of times of the reflection at the reflection surfaces 10a from each other. Therefore, the illuminance distribution of the green light LG that propagates through the region surrounded by the incident end 41a, the exit end 41b, and the reflection surfaces 10a is homogenized in the plane including the D1 direction and the D3 direction. That is, the first light guide element 41 homogenizes the illuminance distribution of the green light LG incident thereon in the plane including the D1 direction and the D3 direction. The green light LG having the homogenized illuminance distribution is emitted from the exit end 41b toward the +D2 side.

Then, the adhesive 50, which bonds the plurality of plate members 10 to each other, will be described. The adhesive 50 bonds the plurality of plate members 10 to each other outside the light guide path to form the first light guide element 41 including the light guide path 41L. The adhesive 50 is disposed along portions of the oblique sides of the trapezoidal shapes in the second member 12 and the fourth member 14. The adhesive 50 is disposed, as a whole, at the exit end 41b side of an intermediate portion M in the length direction (the D2 direction) of the light guide path 41L. Here, the intermediate portion M of the light guide path 41L means a portion located at an equal distance in the D2 direction from the incident end 41a and the exit end 41b.

In the present embodiment, the adhesive 50 is disposed at a position at a distance of about 3/4 of the length from the incident end 41a to the exit end 41b from the incident end 41a toward the exit end 41b. Note that some of the adhesive 50 may be disposed in a region at the incident end 41a side of the intermediate portion M.

The contact area of the adhesive 50 to the plurality of plate members 10 is larger at the exit end 41b side of the intermediate portion M of the light guide path than at the incident end 41a side of the intermediate portion M.

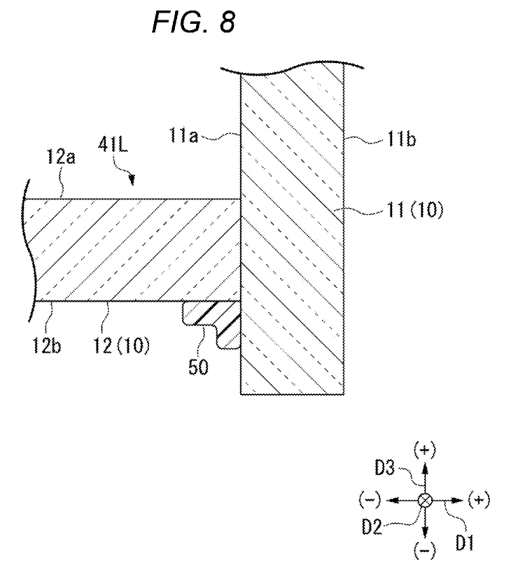

FIG. 8 is a cross-sectional view taken along a line VIII in FIG. 7. FIG. 8 focuses attention only on how the adhesive 50 bonds the first member 11 and the second member 12 for facilitating visualization. As shown in FIGS. 7 and 8, the adhesive 50 is located outside the light guide path defined by the first light guide element 41.

The first member 11 and the second member 12 are disposed so that one side surface of the second member 12 that forms the oblique side portion is in contact with a portion of the first reflection surface 11a of the first member 11. The adhesive 50 bonds a portion outside the light guide path 41L in the first reflection surface 11a to an outer surface 12b located at an opposite side to the second reflection surface 12a in the second member 12. Thus, the contact area of the adhesive 50 to the first member 11 and the second member 12 is larger at the exit end 41b side of the intermediate portion M of the light guide path 41L than at the incident end 41a side of the intermediate portion M. In this way, the first member 11 and the second member 12 are bonded to each other via the adhesive 50. Similarly, the second member 12 and the third member 13, the third member 13 and the fourth member 14, and the fourth member 14 and the first member 11 are bonded to each other via the adhesive 50, respectively.

Note that the adhesive 50 is not required to be disposed in the form of a single block along a part of the oblique side of the trapezoidal shape in each of the second member 12 and the fourth member 14, and may be disposed in a form of a plurality of discontinuous blocks. The contact area in the present embodiment includes not only the area of a continuous contact region, but also a sum of the areas of discontinuous contact regions.

As the adhesive 50, any types of adhesives such as an ultraviolet curing type, a natural curing type, or a thermosetting type may be used. The adhesive 50 is only required to bond the plurality of plate members 10 to each other to form the shape of the first light guide element 41, and may appropriately be changed.

In the first light guide element 41 configured in such a manner, even when the incident opening 45 and the first light source 401 are made close to each other, a part of the green light LG leaks to the outside of the light guide path 41L to become the leakage light LL in some cases. The leakage light LL is generated while the light travels from the first light source 401 toward the incident opening 45 of the first light guide element 41 and leaks to the outside of the light guide path 41L.

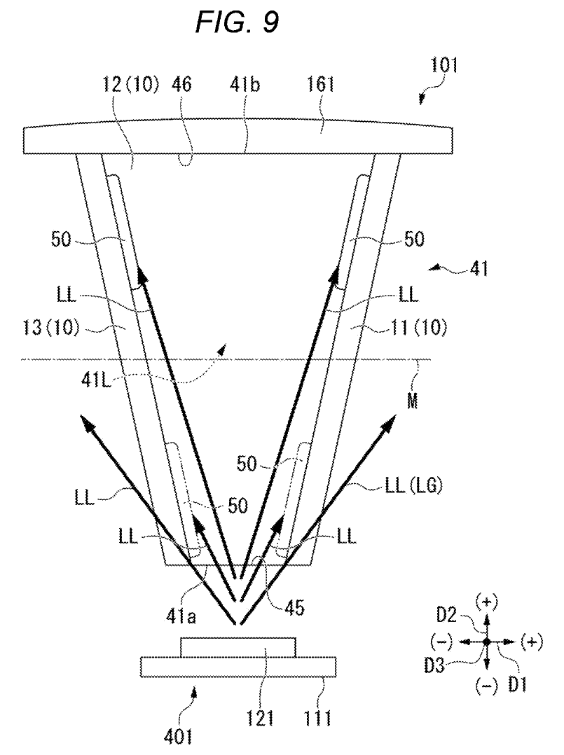

Here, the behavior of the leakage light LL will be described. FIG. 9 is a schematic diagram illustrating the behavior of the leakage light LL. As shown in FIG. 9, the leakage light LL is light output from the first light source 401 along a direction at an angle larger than the taper angle of the trapezoidal shape of each of the second member 12 and the fourth member 14. The leakage light LL contains various angular components, and the leakage light LL output along a direction at an angle slightly larger than the taper angle of the trapezoidal shape of each of the second member 12 and the fourth member 14 is likely to be incident on the side surface at the incident end 41a side in the first light guide element 41.

Incidentally, in order to allow the leakage light LL to reach a side surface at the exit end 41b side in the first light guide element 41, the leakage light LL output in a direction inclining at an angle comparable to the taper angle of the trapezoidal shape of each of the second member 12 and the fourth member 14 needs to travel along an outer side surface of the first light guide element 41 from the incident end 41a side to the exit end 41b side. As described above, the amount of the leakage light LL that reaches the exit end 41b side is sufficiently smaller than the amount of the leakage light LL incident on the incident end 41a side.

Therefore, when the adhesive 50 is disposed at the incident end 41a side, the adhesive 50 is likely to deteriorate due to an increase in the amount of the leakage light LL with which the adhesive 50 is irradiated. In particular, since the green light LG of the present embodiment contains the excitation component having a short wavelength and high energy as described above, the adhesive 50 is likely to deteriorate.

In contrast, in the first light guide element 41 in the present embodiment, since the adhesive 50 is disposed closer to the exit end 41b side than to the incident end 41a side, the leakage light LL that leaks to the outside from the incident opening 45 of the first light guide element 41 is unlikely to be applied to the adhesive 50, and thus, the deterioration of the adhesive 50 can be suppressed. Therefore, a decrease in adhesive strength of the adhesive 50, which bonds the plurality of plate members 10 to each other, can be suppressed.

As described above, the first light guide element 41 in the present embodiment includes the plurality of plate members 10, which define the light guide path having the incident end 41a and the exit end 41b to guide the light, and the adhesive 50, which bonds the plurality of plate members 10 to each other outside the light guide path 41L, the plurality of plate members 10 include the first member 11 having the first reflection surface 11a and the second member 12 having the second reflection surface 12a, and the contact area of the adhesive 50 to the first member 11 and the second member 12 is larger at the exit end 41b side of the intermediate portion M of the light guide path than at the incident end 41a side of the intermediate portion M.

According to the first light guide element 41 in the present embodiment, since the adhesive 50 is disposed closer to the exit end 41b side than to the incident end 41a side, the leakage light LL that leaks to the outside from the incident opening 45 of the first light guide element 41 is unlikely to be applied to the adhesive 50, and thus, the deterioration of the adhesive 50 can be suppressed. Therefore, a decrease in adhesive strength of the adhesive 50, which bonds the plurality of plate members 10 to each other, can be suppressed.

Further, since the bonding surface where the adhesive 50 bonds the plurality of plate members 10 to each other can be widened compared to when the plurality of plate members 10 each has a trapezoidal shape, the adhesive 50 can easily be applied, and the plurality of plate members 10 can easily be assembled.

The first image forming module 100G in the present embodiment can provide an optical module high in reliability by suppressing a decrease in the adhesive strength of the adhesive 50 that bonds the plurality of plate members 10 constituting the first light guide element 41 caused by the leakage light LL of the first light source 401.

Then, the second image forming module 100B will be described. The blue optical module 102 of the second image forming module 100B emits the blue light LB.

The blue optical module 102 includes a second light source 402, a second light guide element 42, and a second collimating element 162. In the blue optical module 102, the second light source 402, the second light guide element 42, and the second collimating element 162 are disposed along an optical axis AX2 of the second light source 402. The optical axis AX2 of the second light source 402 is an axis along a principal ray of light radially emitted from the second light source 402, and is an axis extending in parallel to the D1 direction.

A second light emitting element 122 of the second light source 402 is supported by a second substrate 112. The second substrate 112 is a plate parallel to a plane including the D2 direction and the D3 direction.

The second light emitting element 122 is disposed at a plate surface at the +D1 side in the second substrate 112. The second light emitting element 122 emits the blue light LB having a blue wavelength band in the visible wavelength band. The blue light LB is light in a wavelength band of, for example, 430 nm to 500 nm, and has a peak wavelength at 465 nm. The second light emitting element 122 is configured with, for example, an LED that emits the blue light LB.

The second light guide element 42 is disposed at the optical path of the blue light LB output from the second light source 402. The configuration of the second light guide element 42 is substantially the same as that of the first light guide element 41, and has a light guide path that guides the blue light LB.

The second collimating element 162 collimates, along the D1 direction, the blue light LB output from the second light guide element 42, similarly to the first collimating element 161.

The blue light modulation device 105 includes a second incident-side polarization element 172, a second light modulation element 182, and a second exit-side polarization element 176. The blue light modulation device 105 is disposed at the optical path of the blue light LB output from the second collimating element 162.

The second incident-side polarization element 172 outputs, toward the +D1 side along the D1 direction, predetermined polarized light out of the blue light LB output from the second collimating element 162.

The second light modulation element 182 modulates the blue light LB output from the second incident-side polarization element 172. The second light modulation element 182 generates blue image light IB based on blue image information. The second light modulation element 182 emits the blue image light IB toward the +D1 side along the D1 direction.

The second exit-side polarization element 176 outputs, toward the +D1 side along the D1 direction, predetermined polarized light out of the blue image light IB output from the second light modulation element 182.

In the second image forming module 100B of the present embodiment, the configuration of the second light guide element 42 is substantially the same as that of the first light guide element 41. Therefore, the second image forming module 100B can suppress the deterioration of the adhesive constituting the second light guide element 42 caused by the leakage light of the second light source 402.

Then, the third image forming module 100R will be described. The red optical module 103 of the third image forming module 100R emits red light LR. The red light LR emitted from the red optical module 103 travels toward the -D1 side along the D1 direction.

The red optical module 103 includes a third light source 403, a third light guide element 43, and a third collimating element 163. In the red optical module 103, the third light source 403, the third light guide element 43, and the third collimating element 163 are disposed along an optical axis AX3 of the third light source 403. The optical axis AX3 of the third light source 403 is an axis along a principal ray of light radially emitted from the third light source 403 and is an axis extending in parallel to the D1 direction, and the optical axis AX2 of the second light source 402 and the optical axis AX3 of the third light source 403 coincide with each other.

A third light emitting element 123 of the third light source 403 is supported by a third substrate 113. The third substrate 113 is a plate parallel to the plane including the D2 direction and the D3 direction.

The third light emitting element 123 is disposed at a plate surface at the -D1 side in the third substrate 113. A light emitting surface of the third light emitting element 123 is a surface at the -D1 side opposite to the surface at which the third light emitting element 123 is provided to the third substrate 113. The third light emitting element 123 emits the red light LR having a red wavelength band in the visible wavelength band. The red light LR is light in a wavelength band of, for example, 610 nm to 700 nm, and has a peak wavelength at 655 nm. Similarly to the second light emitting element 122, the third light emitting element 123 is configured with, for example, an LED that emits the red light LR.

The third light guide element 43 is disposed at the optical path of the red light LR output from the third light source 403. The configuration of the third light guide element 43 is substantially the same as that of the first light guide element 41, and has a light guide path that guides the red light LR.

The third collimating element 163 collimates, along the D1 direction, the red light LR output from the third light guide element 43, similarly to the first collimating element 161 and the second collimating element 162.

The red light modulation device 106 includes a third incident-side polarization element 173, a third light modulation element 183, and a third exit-side polarization element 177. The red light modulation device 106 is disposed at the optical path of the red light LR output from the third collimating element 163.

Similarly to the second incident-side polarization element 172, the third incident-side polarization element 173 outputs, toward the -D1 side along the D1 direction, predetermined polarized light out of the red light LR output from the third collimating element 163.

Similarly to the first light modulation element 181 and the second light modulation element 182, the third light modulation element 183 modulates the red light LR output from the third incident-side polarization element 173. The third light modulation element 183 generates red image light IR. The third light modulation element 183 outputs the red image light IR toward the -D1 side along the D1 direction.

Similarly to the first exit-side polarization element 175 and the second exit-side polarization element 176, the third exit-side polarization element 177 outputs, toward the -D1 side along the D1 direction, predetermined polarized light out of the red image light IR output from the third light modulation element 183.

In the third image forming module 100R in the present embodiment, the configuration of the third light guide element 43 is substantially the same as that of the first light guide element 41. Therefore, the third image forming module 100R can suppress the deterioration of the adhesive constituting the third light guide element 43 caused by the leakage light of the third light source 403.

The light combining element 200 is disposed in a region where the optical path of the blue image light IB, the optical path of the green image light IG, and the optical path of the red image light IR cross each other. The light combining element 200 combines the colored image light IG emitted from the first image forming module 100G, the colored image light IB emitted from the second image forming module 100B, and the colored image light IR emitted from the third image forming module 100R with each other to emit combined image light IM thus generated to the +D2 side along the D2 direction.

The projection optical system 250 is disposed at the optical path of the combined image light IM emitted from the light combining element 200. The projection optical system 250 displays, in an enlarged manner, images input to the first light modulation element 181, the second light modulation element 182, and the third light modulation element 183 on a screen SCR by projecting the images on the screen SCR.

As described above, the projector 301 according to the present embodiment includes the first image forming module 100G including the green optical module 101 and the first light modulation element 181 that modulates the green light LG based on the image information, the second image forming module 100B including the second light modulation element 182 that modulates the blue light LB based on the image information, the third image forming module 100R including the third light modulation element 183 that modulates the red light LR based on the image information, the light combining element 200 that combines the green image light IG emitted from the first image forming module 100G, the blue image light IB emitted from the second image forming module 100B, and the red image light IR emitted from the third image forming module 100R with each other to emit the combined image light IM, and the projection optical system 250 that projects the combined image light IM emitted from the light combining element 200.

According to the projector 301 of the present embodiment, it is possible to provide a projector high in reliability by including the first image forming module 100G in which a decrease in reliability due to multiple reflection of light is suppressed.

In the present embodiment, the filter 164 and the polarization plate 165 are disposed so as to be inclined from the state perpendicular to the optical axis AX1 of the first light source 401, but either one of the filter 164 and the polarization plate 165 may be disposed so as to be inclined from the state perpendicular to the optical axis AX1.

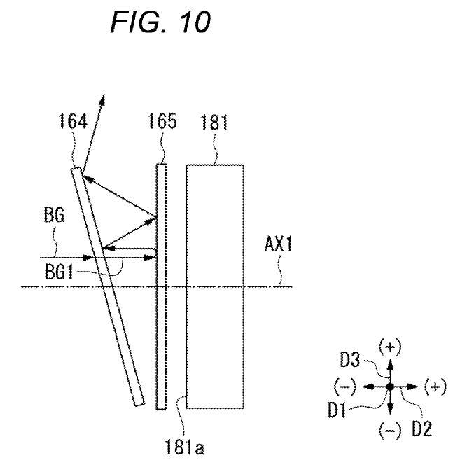

FIG. 10 is a diagram illustrating an arrangement configuration of the filter 164 and the polarization plate 165 related to a modified example. As shown in FIG. 10, when either one of the filter 164 and the polarization plate 165 is inclined, it is preferable to dispose the filter 164 so as to be inclined from the state perpendicular to the optical axis AX1. Specifically, the polarization plate 165 is disposed perpendicular to the optical axis AX1, and the filter 164 is disposed so as to be inclined from the state perpendicular to the optical axis AX1.

The polarization plate 165 has incident angle dependency that the transmittance changes in accordance with the incident angle of light. Normally, the polarization plate 165 is designed to have a desired transmittance in the state perpendicular to the optical axis AX1. Therefore, as the polarization plate 165 is disposed so as to be inclined from the state perpendicular to the optical axis AX1, the transmittance of the green light LG in the polarization plate 165 may decrease, and there is a possibility that deterioration of the contrast of the green image light IG generated by the first light modulation element 181 is incurred.

According to the configuration shown in FIG. 10, since the polarization plate 165 having the incident angle dependency is disposed in parallel to a light incident plane 181a of the first light modulation element 181, the green light LG transmitted through the filter 164 is efficiently incident on the polarization plate 165.

In the configuration shown in FIG. 10, since the filter 164 and the polarization plate 165 are non-parallel to each other, the direction of the transmission component BG1 transmitted through the filter 164 is changed so as to approach the direction parallel to the D3 direction every time the transmission component BG1 is reflected between the filter 164 and the polarization plate 165, and the transmission component BG1 is emitted to the outside of the area between the filter 164 and the polarization plate 165, travels as the stray light in the projector 301, and is absorbed by the light absorption member (not shown).

Therefore, according to the present modified example, it is possible to realize a configuration in which the deterioration of the polarization plate 165 due to the multiple reflection of the excitation light BG is suppressed similarly to the embodiment described above while suppressing a decrease in contrast of the green image light IG due to the first light modulation element 181.

In the projector 301 according to the embodiment described above, the second light guide element 42 of the second image forming module 100B and the third light guide element 43 of the third image forming module 100R have the configuration in which the plurality of plate members is bonded to each other with the adhesive similarly to the first light guide element 41 of the green optical module 101, which is the optical module according to the present disclosure, but the configurations of the second light guide element 42 and the third light guide element 43 are not limited thereto. For example, the second light guide element 42 and the third light guide element 43 may be formed of a light transmissive member having a truncated quadrangular pyramid shape.

Here, when substantially the same configuration as that of the first light guide element 41 is adopted for either the second light guide element 42 or the third light guide element 43, it is preferable to apply that configuration to the second light guide element 42 corresponding to the blue light LB. The reason for this is that the blue light LB has a shorter wavelength than the red light LR and thus has a larger energy, which is likely to cause the deterioration of the adhesive strength. As described above, by adopting the same configuration as the first light guide element 41 for the light guide element that guides the blue light LB that is likely to cause the deterioration, it is possible to more effectively suppress the decrease in the adhesive strength of the adhesive.

Further, in the green optical module 101, the first light guide element 41 and the first collimating element 161 may be omitted in accordance with the in-plane illuminance distribution and the parallelism of the green light LG emitted from the first light source 401. Similarly, in the second image forming module 100B, the second light guide element 42 and the second collimating element 162 may be omitted in accordance with the in-plane illuminance distribution and the parallelism of the blue light LB, and in the third image forming module 100R, the third light guide element 43 and the third collimating element 163 may be omitted in accordance with the in-plane illuminance distribution and the parallelism of the red light LR.

The present disclosure will be summarized below as appendices.

### Appendix 1

An optical module including:
a first light source including a light emitting element configured to emit excitation light and a wavelength conversion element configured to convert the excitation light into light in a different wavelength band;
a filter that cuts the excitation light contained in light incident from the first light source; and
a polarization plate on which the light transmitted through the filter is incident, wherein
   at least one of the filter and the polarization plate is disposed so as to be inclined from a state perpendicular to an optical axis of the light emitted from the first light source.

According to the optical module having this configuration, since the filter and the polarization plate are inclined from the state perpendicular to the optical axis, it is possible to change the direction of the transmission component of the excitation light toward the direction orthogonal to the optical axis every time the transmission component is reflected between the filter and the polarization plate, and to emit the transmission component of the excitation light to the outside of an area between the polarization plate and the filter. Therefore, it is possible to provide a highly reliable optical module in which the transmission component of the excitation light is prevented from being multiply reflected between the filter and the polarization plate to thereby suppress a decrease in reliability due to deterioration of the polarization plate caused by the excitation light.

### Appendix 2

The optical module according to Appendix 1, further including

a holding member that is disposed between the filter and the polarization plate and holds the filter and the polarization plate so as to be non-parallel to each other.

According to this configuration, the filter and the polarization plate can be held in a predetermined posture by the holding member. In addition, since the filter and the polarization plate are disposed so as to be non-parallel to each other, even when the transmission component of the excitation light is incident on the filter at any incident angle, multiple reflection is less likely to occur between the filter and the polarization plate.

### Appendix 3

The optical module according to Appendix 2, wherein

the holding member includes a frame-shaped body having an opening, and a fixing member disposed on a periphery of the opening and configured to fix the filter and the polarization plate to the frame-shaped body.

According to this configuration, the holding member can hold the filter and the polarization plate without blocking light to be incident on the filter and the polarization plate.

### Appendix 4

The optical module according to any one of Appendices 1 to 3, wherein

the filter is inclined at an angle θ1 (where 0°<θ1≤5°) from the state perpendicular to the optical axis, and

the polarization plate is inclined at an angle θ2 (where 0°<θ2≤5°) from the state perpendicular to the optical axis toward an opposite side to the inclination of the filter.

According to this configuration, since the filter and the polarization plate are disposed at an appropriate angle with respect to the optical axis, the transmission component of the excitation light reflected between the filter and the polarization plate can be favorably emitted to the outside of the area between the filter and the polarization plate.

### Appendix 5

The optical module according to Appendix 4, wherein

the polarization plate is disposed perpendicularly to the optical axis, and

the filter is disposed so as to be inclined from the state perpendicular to the optical axis.

According to this configuration, since the polarization plate having incident angle dependency is disposed perpendicularly to the optical axis, the light can be efficiently incident on the polarization plate.

### Appendix 6

The optical module according to any one of Appendices 1 to 5, further including:
a light guide element disposed between the first light source and the filter and configured to guide light incident from the first light source; and
a collimating element disposed between the first light source and the filter and configured to collimate light incident from the light guide element.

According to this configuration, the light emitted from the first light source can be collimated and efficiently guided to the subsequent stage.

### Appendix 7

The optical module according to Appendix 6, wherein

the light guide element includes:
a plurality of plate members configured to define a light guide path configured to guide light incident via an incident end and to output the light via an exit end; and
an adhesive configured to bond the plurality of plate members to each other outside the light guide path,
   the plurality of plate members includes a first member having a first reflection surface and a second member having a second reflection surface, and
   contact areas of the adhesive to the first member and the second member are larger at the exit end side of an intermediate portion of the light guide path than at the incident end side of the intermediate portion.

A part of the excitation light leaks to the outside of the light guide path to become leakage light in some cases. The leakage light is light output to the outside of the outer side surfaces of the plurality of plate members. The leakage light contains various angular components, and the leakage light output along directions away from the outer side surfaces of the plurality of plate members is likely to be incident on the side surface at the incident end side in the light guide element. Incidentally, in order to allow the leakage light to reach the side surface at the exit end side in the light guide element, the leakage light needs to travel along the outer side surfaces of the plurality of plate members. Accordingly, the amount of the leakage light that reaches the exit end side is sufficiently smaller than the amount of the leakage light incident on the incident end side. Therefore, when the adhesive is disposed at the incident end side, the adhesive is likely to deteriorate due to an increase in the amount of the leakage light with which the adhesive is irradiated. In contrast, according to this configuration, since the adhesive is disposed closer to the exit end side than to the incident end side, the leakage light that leaks to the outside from the incident opening of the light guide element is unlikely to be applied to the adhesive, and thus, the deterioration of the adhesive can be suppressed. Therefore, a decrease in the adhesive strength of the adhesive, which bonds the plurality of plate members to each other, can be suppressed.

### Appendix 8

The optical module according to Appendix 7, wherein

the plurality of plate members further includes a third member having a third reflection surface and a fourth member having a fourth reflection surface, and

the light guide path is configured by the first reflection surface of the first member and the third reflection surface of the third member facing each other, and the second reflection surface of the second member and the fourth reflection surface of the fourth member facing each other.

According to this configuration, the light guide element can be easily manufactured by using the four plate members.

### Appendix 9

A projector including

a first image forming module including the optical module according to any one of Appendices 6 to 8, and a first light modulation element configured to modulate light incident from the polarization plate of the optical module based on image information.

According to the projector having this configuration, it is possible to provide a highly reliable projector in which the decrease in reliability due to the multiple reflection of light is suppressed in the first image forming module.

### Appendix 10

The projector according to Appendix 9, further including:
a second image forming module including a second light modulation element configured to modulate, based on the image information, blue light incident from a second light source;
a third image forming module including a third light modulation element configured to modulate, based on the image information, red light incident from a third light source;
a light combining element configured to combine green image light emitted from the first image forming module, blue image light emitted from the second image forming module, and red image light emitted from the third image forming module with each other to emit light combined; and
a projection optical system configured to project the light emitted from the light combining element, wherein
   the excitation light is light in a wavelength band of 400 nm to 450 nm, and the light in the different wavelength band is light in a green wavelength band.

According to this configuration, in a three-plate projector including the image forming modules corresponding to three colors, it is possible to suppress the decrease in reliability due to the multiple reflection of the excitation light in the green image forming module using the excitation light having a short wavelength.

What is claimed is:

1. An optical module comprising:
a first light source including a light emitting element configured to emit excitation light and a wavelength conversion element configured to convert the excitation light into light in a different wavelength band;
a filter that cuts the excitation light contained in light incident from the first light source; and
a polarization plate on which the light transmitted through the filter is incident, wherein
at least one of the filter and the polarization plate is disposed so as to be inclined from a state perpendicular to an optical axis of the light emitted from the first light source.

2. The optical module according to claim 1, further comprising
a holding member that is disposed between the filter and the polarization plate and holds the filter and the polarization plate so as to be non-parallel to each other.

3. The optical module according to claim 2, wherein
the holding member includes a frame-shaped body having an opening, and a fixing member disposed on a periphery of the opening and configured to fix the filter and the polarization plate to the frame-shaped body.

4. The optical module according to claim 1, wherein
the filter is inclined at an angle θ1 (where 0°<θ1≤5°) from the state perpendicular to the optical axis, and
the polarization plate is inclined at an angle θ2 (where 0°<θ2≤5°) from the state perpendicular to the optical axis toward an opposite side to the inclination of the filter.

5. The optical module according to claim 1, wherein
the polarization plate is disposed perpendicularly to the optical axis, and
the filter is disposed so as to be inclined from the state perpendicular to the optical axis.

6. The optical module according to claim 1, further comprising:
a light guide element disposed between the first light source and the filter and configured to guide light incident from the first light source; and
a collimating element disposed between the first light source and the filter and configured to collimate light incident from the light guide element.

7. The optical module according to claim 6, wherein
the light guide element includes:
a plurality of plate members configured to define a light guide path configured to guide light incident via an incident end and to output the light via an exit end; and
an adhesive configured to bond the plurality of plate members to each other outside the light guide path,
the plurality of plate members includes a first member having a first reflection surface and a second member having a second reflection surface, and
contact areas of the adhesive to the first member and the second member are larger at the exit end side of an intermediate portion of the light guide path than at the incident end side of the intermediate portion.

8. The optical module according to claim 7, wherein
the plurality of plate members further includes a third member having a third reflection surface and a fourth member having a fourth reflection surface, and
the light guide path is configured by the first reflection surface of the first member and the third reflection surface of the third member facing each other, and the second reflection surface of the second member and the fourth reflection surface of the fourth member facing each other.

9. A projector comprising
a first image forming module including the optical module according to claim 6, and a first light modulation element configured to modulate light incident from the polarization plate of the optical module based on image information.

10. The projector according to claim 9, further comprising:
a second image forming module including a second light modulation element configured to modulate, based on the image information, blue light incident from a second light source;
a third image forming module including a third light modulation element configured to modulate, based on the image information, red light incident from a third light source;
a light combining element configured to combine green image light emitted from the first image forming module, blue image light emitted from the second image forming module, and red image light emitted from the third image forming module with each other to emit light combined; and
a projection optical system configured to project the light emitted from the light combining element, wherein
the excitation light is light in a wavelength band of 400 nm to 450 nm, and the light in the different wavelength band is light in a green wavelength band.
